(19) United States
(12) Patent Application Publication
(10) Pub. No.: US 2020/0404744 A1
(43) Pub. Date: Dec. 24, 2020

(54) UNDERWATER ACOUSTIC SENSOR NETWORKS

(71) Applicant: University of Connecticut, Farmington, CT (US)

(72) Inventors: Reda Ammar, Mansfield Center, CT (US); Hussain Albarakati, Willington, CT (US); Sanguthevar Rajasekaran, Ellington, CT (US); Raafat Elfouly, Mansfield Center, CT (US)

(73) Assignee: University of Connecticut, Farmington, CT (US)

(21) Appl. No.: 16/907,220

(22) Filed: Jun. 20, 2020

Related U.S. Application Data
(60) Provisional application No. 62/864,736, filed on Jun. 21, 2019.

(51) Int. Cl. H04W 84/20; H04B 13/02; H04B 11/00; H04W 40/10

(52) U.S. Cl. CPC H04W 84/20; H04W 40/10; H04B 11/00; H04B 13/02

(57) ABSTRACT

The present disclosure is directed to a system and method for handling data in an underwater acoustic sensors network, the system comprises a low power computing system configured to function underwater, the computing system including a processor and a memory in communication with the processor, wherein the memory stores a set of instructions executable by the processor, the set of instructions when executed by the processor, cause the processor to receive a primary data from a plurality of master nodes; process the primary data using one or more data reduction algorithms to obtain a resultant data, wherein the resultant data is of a reduced size than the primary data; perform some generic computations on the resultant data, and transmit the resultant data to a gateway.

### CROSS-REFERENCE TO RELATED APPLICATIONS

This application claims priority to the U.S. provisional patent application Ser. No. 62/864,736, entitled “UNDERWATER ACOUSTIC SENSOR NETWORKS” filed on Jun. 21, 2019, which is incorporated herein by reference in its entirety. FIELD OF INVENTION.

### FIELD OF THE INVENTION

The present disclosure relates to underwater acoustic sensor networks (UWASNs), and particularly, the present disclosure relates to a system and method for handling of data in the underwater acoustic sensor networks (UWASNs).

### BACKGROUND

Underwater sensor nodes are used for a variety of applications including exploration of natural undersea resources, oceanographic data collection, aided navigation and tactical surveillance, disaster prevention, seismic monitoring, oil well inspection, military applications, and like. Underwater acoustic sensor networks (UWASNs) are the enabling technology used to extract data for the above applications. Underwater networks consist of a variable number of sensors and vehicles that are deployed to perform collaborative monitoring tasks over a given area. Underwater communication of data can be achieved by sound propagation known as acoustic communication. The acoustic communication suffers from the limitation of low data rates since acoustic waves are used for data transmission instead of electromagnetic waves.

Conventional UWASNs are generally restricted to data sensing, sending, and data transmission. The data collected is often voluminous, and processing the data becomes a big challenge. Typically, all the data can be sent to a computer on the surface and let this computer analyze the data. However, this approach is problematic in many ways, e.g., (a) because of slow acoustic communication, the time for transmitting the data may be very large, (b) many applications require real-time processing and conventional transmission of the data to the surface may not be able to satisfy real-time constraints, and (iii) the energy consumed may be exceedingly large.

Thus, a need is appreciated for a system that can efficiently handle the data collected from the underwater sensor nodes. A need is appreciated for a system and method for efficiently handling the data in the UWASNs.

### SUMMARY OF THE INVENTION

The principal object of the present disclosure is therefore directed to a system and method for handling data in an underwater acoustic sensor network.

In one aspect, the present disclosure is directed to a system and method that provides enhanced handling of data in UWASNs. The system provides for enhanced underwater networking capabilities and enables real-time reporting. The system can be positioned underwater and includes a receiver for receiving signals from the sensor nodes; a processor for the transformation of the signals received from the sensor nodes to primary data and appropriate data reduction of the primary data to obtain the resultant data; and a transmitter for transmitting the resultant data to a gateway at the surface. In one implementation, a variety of data reduction techniques may be employed that preserve the requisite information for transmission to the surface computer for further transmission/processing/analysis.

In one aspect, the system according to the present disclosure is extremely power efficient.

In one aspect, the system according to the present disclosure provides for real-time and non-real-time applications.

In one aspect, the system disclosed herein includes a data reduction algorithm, such as Apriori algorithm for extracting resultant data from the primary data captured from the master nodes. The resultant data is of reduced size. The primary data can be subjected to data reduction algorithm and any other processing technique for reducing and refining the data and includes compression. The resultant data can then be transmitted to a gateway. When the data is reduced drastically using the system as disclosed herein, the transmission time for the reduced data is significantly decreased and the energy spent in data transmission is also low. By choosing an appropriate data reduction technique, the systems and methods of the present disclosure are effective in delivering data to the gateway. The resultant data maintains all key aspects of the primary data despite the data reduction implemented sub-surface.

In one aspect, the system disclosed herein, includes a data collection module for enhancing data collection while reducing the end to end delays and power consumption.

In one aspect, the present disclosure is directed to an underwater acoustic sensor network that includes a plurality of sensor nodes, the plurality of sensor nodes aggregated into clusters, each cluster having a master node, and each master node connected to a virtual machine of the system. The system can directly or indirectly connect to one or more gateways. The system can indirectly connect to one or more gateways through relay nodes.

In one aspect, the present disclosure is directed to a method of underwater networking that minimizes the end to end delays and power consumption of the underwater acoustic sensor network. The method includes the step of dividing the sensor nodes into clusters, each cluster having a master node that can connect to other sensor nodes in the cluster. The master nodes can connect to a system of the underwater acoustic sensor network.

These and other objects and advantages of the embodiments herein will become readily apparent from the following detailed description.

### BRIEF DESCRIPTION OF THE DRAWINGS

FIG. 1 is a schematic showing one implementation of the underwater acoustic sensor network.

FIG. 2 is a block diagram showing the underwater acoustic sensor network of FIG. 1.

FIG. 3 is a system diagram showing one implementation of the system disclosed herein.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as devices and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and devices are shown in block diagram form in order to facilitate describing the subject innovation. Moreover, the drawings may not be to scale.

As noted above, the disclosed system and method enhance the performance and utility of underwater acoustic sensor networks (UWASNs) by performing data reduction underwater before transmitting the reduced data to a gateway physically located at the surface for further transmission of data or processing/analysis. According to one implementation, a low-power system can be positioned underwater that is utilized to perform appropriate data reduction. Only the reduced data is transmitted to a gateway at the surface. After the data reduction, some computations could also be performed on the reduced data before transmission to the surface.

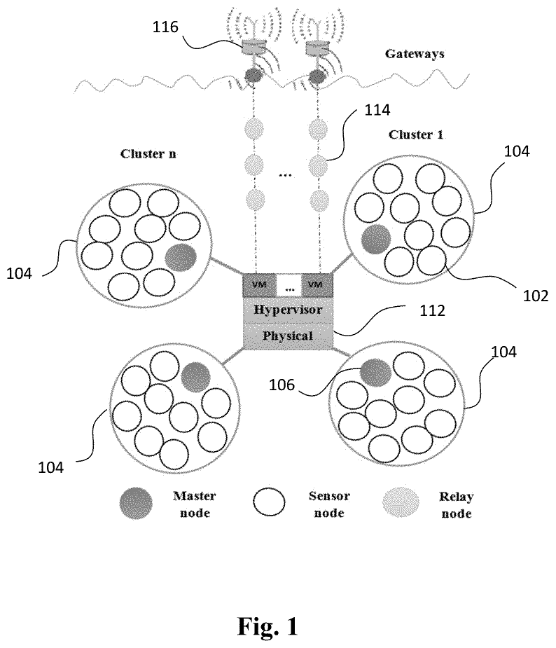

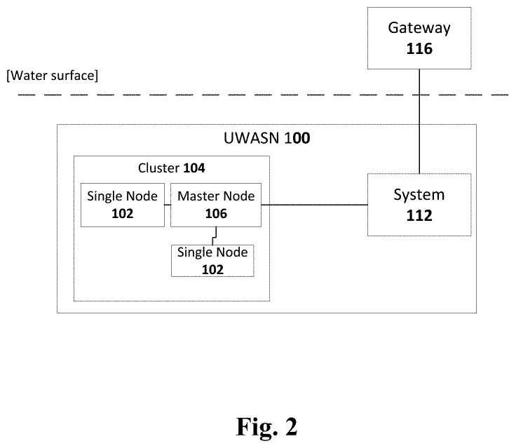

Now referring to FIGS. 1 and 2, which shows one implementation of the underwater acoustic sensor network (UWASN) 100. FIGS. 1 and 2 shows four clusters 104 of sensor nodes 102, each cluster 104 is having a master node 106. Each master node 106 can connect to other sensor nodes 102 in the cluster 104. The present disclosure uses a heuristic algorithm and SN topologies to enhance data collection in the lowest layer of the SN architecture. The algorithm separates sensor nodes 102 into clusters of sensors 104 and then identifies the best location for master nodes (MNs) (one for each cluster) before it finally identifies the best location of the system 112. The system 112 includes Virtual machines (VMs) and a hypervisor. The hypervisor runs several virtual machines, wherein each virtual machine can be connected to each master node 106. The system 112 can be connected to a gateway 116 through relay nodes 114. The number of relay nodes depends on the distance between the gateway 116 and the system 112.

The present disclosure is directed to an underwater acoustic sensor network. The underwater acoustic sensor network includes a plurality of sensor nodes (SNs) that can be arranged underwater in clusters. Each cluster having a master sensor node (MNs) that connects with other sensors nodes in the cluster. Arrangement of the sensors in clusters offers significant benefits for harnessing data collected by the underwater acoustic sensor network. In one implementation, SNs that are randomly deployed in an area of cover may function to leverage the advantageous heuristic algorithms and topologies to improve end-to-end delay-related performance, network lifetime, and data balancing/load across the MNs. The network topology is thus selected to enhance the overall system performance in terms of minimizing the end-to-end delay and power consumption (i.e. extended lifetime of the network). The network topology can be optimized to reduce the data gathering latency and to keep the data load balanced among the master nodes.

To meet Realtime constraints, the present disclosure aims to enhance the performance of the UWASNs in three ways: (1) sensor nodes (SNs) deployment, (2) data collection, and (3) information extraction. In one implementation, the underwater system networks employ heuristic and exact algorithms and SN topologies to enhance data collection in the lowest layer of the SNs architecture. In one implementation, algorithms include modified K-Means Algorithm (O(mn²)) for a homogeneous network and “Minimize End-to-End delay” algorithm (O(mn²)) for both homogeneous and heterogeneous network. Both the algorithms are known in the art. A skilled person will appreciate that other algorithms could also be employed without departing from the scope of the present invention. Proposed topologies include (a) random locations based on a large area, (b) random locations based on the cells, and (c) random locations based on the cells and distances. In one implementation, the “Minimize End-to-End delay” algorithm can be implemented to various network topologies and evaluating network performance in terms of (a) data gathering, (b) standard deviation (SD), (c) Coverage area, and (d) network lifetime. The above reconfigurable UWASN architecture optimizes both the end-to-end delay and power consumption in the deep water.

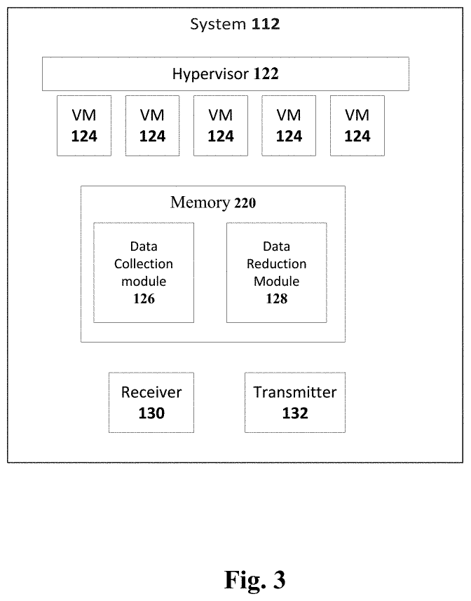

Referring to FIG. 3 which is a block diagram showing one implementation of the system 112 including the hypervisor 122 which is a part of the processor. The hypervisor 122 can run several virtual machines (VMs) 124, each of which is connected to each master node of a cluster. Each cluster 104 of sensor nodes 102 has one master node 106 that retrieves the data from several SNs in its associated cluster and delivers it to the system 112 through receiver 130 of the system. Each VM 124 receives primary data from the associated master node using the data collection module 126. The primary data can then be processed by the VMs using the data reduction module 128 to resultant data. The resultant data can then be sent to a gateway 116 directly or through relay nodes 114. The system 112 can include a transmitter 132 for sending the resultant data.

The system 112 comprises the memory 220 which includes the data collection module 126 and data reduction module 128. The data collection module 126 includes a set of instructions which when executed by a processor can receive signal data from the master nodes. The data collection module 126 then converts the signal data into primary data that can be processed by the virtual machines 124. The data collection module 126 can include details of sensor node topologies and UWASN architecture.

The data reduction module 128 includes a set of instructions which when executed by the processor can process the primary data into resultant data, the resultant data if of reduced size. The data reduction module 128 includes one or more algorithms for information extraction. The one or more algorithms can include association rules mining algorithms, or any other algorithm known for data reduction. In one implementation, the data reduction module 128 can include algorithms, such as the Class sample extraction Algorithm, weighted record sample algorithm, and Apriori algorithms for the reduction of primary data to obtain resultant data. Apriori algorithm is known in the art for extracting useful information from big data.

There are many ways to perform data reduction. Indeed, any data reduction technique that closely preserves the initial information collected/obtained by the UWASNs is appropriate. For example, the data reduction module 128 may utilize any rules mining algorithm (such as the Apriori algorithm) for data reduction. After finding all (or substantially all) the association rules in the data, the data reduction module 128 may operate to transmit the rules as the reduced data. Another way to reduce data is to employ the random projection algorithm of Johnson and Linden Strauss. A theorem of Johnson and Linden Strauss states that if we are given n points in an arbitrary Euclidean space, we can randomly project them onto an O(log n)-dimensional space, such that pairwise distances are very closely preserved. Note that the dimension of the projected space is a function of only “n” and is independent of the dimension of the original space. This algorithm is known in the art for diverse applications. For instance, this random projection algorithm has been used in the genotype-phenotype correlational analysis. There are available many other data reduction algorithms that may be employed, as will be apparent to persons skilled in the art, without departing from the spirit or scope of the present disclosure.

In one implementation, the present disclosure provides a Weighted Records Sample Algorithm for data reduction. The steps of the algorithm are as below:
Generate random data for different SNs
Calculate the weight of each feature. The weight of each feature is calculated by dividing the value of each record to the maximum value of the feature. Then, the resulting value is multiplied by a certain percentage. The percentage of each feature is 20%, for example. The total of percentage should be 100%.
Compute the total weight of each record. The weight of each record is written as:

$${\sum }_{i = 1}^{j} \frac{{V}_{i}}{{M}_{i}} * {C}_{i}$$

Where Vi represent as the value of each feature, Mi is maximum value of each feature and Ci is the value of the percentage.
Generate the sample of records based on the condition of the record weight value.
Extract the information from the sample. Here, the information is represented as sample characteristics such as the average, mean, or variance. The sample characteristics formula can be written as:

$$[ \begin{matrix}Information \\ average mean veriance\end{matrix} ] = [ \begin{matrix}… \\ Sample \\ …\end{matrix} ] \times [ \begin{matrix}single ratio \\ {∝}_{1} {∝}_{2} {∝}_{3}\end{matrix} ] .$$

The VMs can send the information directly to the Gateways (Gs) or send a suitable sample and its information to the Gs. The goal is to send information and a suitable sample to enhance the error correction at the surface because the UWASNs suffer from data loss during the vertical communication.

In one implementation, Deployment-based sensor topologies can also be used to enhance the performance of the UWASNs in terms of data gathering delay and power consumption (i.e., extended network life). Herein are disclosed three types of network topologies according to SNs randomly deployed in the square area cover. Disclosed network topologies merge the minimization of the end-to-end delay algorithm and the deployment-based sensor topologies to improve the end-to-end delay, the network lifetime, and keeping the data equal in MNs. The minimize end-to-end delay algorithm can be applied to each sensor topology to find the optimal topology. Deployment-based sensor topologies are as follows.
Sensor Topology #1: Random locations based on a large area: Here, the SNs are randomly deployed on a large area, which may cause a congestion of SNs in a small area.
Sensor Topology #2: Random locations based on the cells: In this sensor topology, the square area is divided into cells according to the number of SNs and in each cell deployment one SN randomly. In this way, congestion of SNs in a small area can be avoided.
Sensor Topology #3: Random locations based on the cells and distances: This is similar to sensor topology #2, but the distances between the SNs are equivalent.

Thus, the systems and methods of the present disclosure offer significant benefits for harnessing data collected by UWASNs, saving time, energy, and money relative to alternative data processing option. In addition, the disclosed systems and methods advantageously support/facilitate real-time decision making. Of note, there are many applications that call for real-time performance. For instance, disaster response requires decisions to be made on a real-time basis and the ability to do so is greatly enhanced by the disclosed systems/methods.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for handling data in an underwater acoustic sensors network, the system comprising:
a low power underwater computing system, the computing system comprises a processor and a memory in communication with the processor, wherein the memory stores a set of instructions executable by the processor, the set of instructions when executed by the processor, causes the processor to:
receive a primary data from a plurality of master nodes;
process the primary data to obtain a resultant data, the resultant data is of a reduced size; and
transmit the resultant data to at least one gateway.

2. The system of claim 1, wherein the processor comprises a hypervisor and a plurality of virtual machines, each of the plurality of virtual machines coupled to each of the plurality of master nodes.

3. The system of claim 2, wherein at least one of the plurality of virtual machine is configured for real-time application of an underwater acoustic sensors network.

4. The system of claim 1, wherein the system further comprises a receiver configured to receive signal data from the plurality of master nodes.

5. The system of claim 4, wherein the processor further:
transforms the signal data to the primary data.

6. The system of claim 1, wherein the primary data is processed using one or more data reduction algorithms based on association rule mining.

7. The system of claim 6, wherein the one or more data reduction algorithms includes an apriori algorithm.

8. The system of claim 1, where the primary data is processed using one or more data reduction algorithms.

9. The system of claim 4, wherein the system further comprises a transmitter configured to transmit the resultant data to one or more gateways.

10. A method for configuring an underwater acoustic sensors network comprises:
providing at least one cluster below a surface of a body of water, each cluster comprises a plurality of sensor nodes and a master node connected to the plurality of sensor nodes;
providing an underwater computing system, the computing system coupled to the master node of the at least one cluster;
receiving, by the underwater computing system, from the master node, a primary data;
processing, by the underwater computing system, using one or more data reduction algorithms, the primary data to obtain a resultant data of a reduced size; and
transmitting, by the underwater computing system, the resultant data to one or more gateways.

11. The method of claim 10 wherein the method further comprises the step of optimizing positions of the master node and the underwater computing system for minimizing end to end delays and power consumption.

12. An underwater acoustic sensors network comprising:
a plurality of sensor nodes configured to be deployed underwater, the plurality of the sensor nodes arranged into at least one cluster, each of the at least one cluster comprises a master node;
a low power underwater computing system coupled to the master node, the computing system comprises a processor and a memory in communication with the processor, wherein the memory stores a set of instructions executable by the processor, the set of instructions when executed by the processor, cause the processor to:
receive a primary data from the master node;
process the primary data using one or more data reduction algorithms to obtain a resultant data, the resultant data is of a reduced size; and
transmit the resultant data to a gateway.

13. The underwater acoustic sensors network of claim 12, the master node and the computing system are arranged for minimizing end to end delays and power consumption.

14. The underwater acoustic sensors network of claim 12, wherein the one or more data reduction algorithms are based on association rule mining.

15. The underwater acoustic sensors network of claim 12, wherein the one or more data reduction algorithms includes an apriori algorithm.
